(19) United States
(12) Patent Application Publication
(10) Pub. No.: US 2017/0239027 A1
(43) Pub. Date: Aug. 24, 2017

(54) ORAL HYGIENE DEVICE FOR THE FLOSSING OF TEETH

(71) Applicant: Dargan Dental Ltd., Dublin (IE)

(72) Inventor: Joseph Dargan, Oldcastle (IE)

(21) Appl. No.: 15/051,768

(22) Filed: Feb. 24, 2016

(51) Int. Cl. A61C 15/04

(52) U.S. Cl. CPC A61C 15/046

(57) ABSTRACT

A dental flossing apparatus having a single continuous loop of dental floss passing freely through and held by apertures, which may be located either within the body of each of two rings, or in an eyelet on each of the rings, the rings being suitable for placing on the long fingers of both hands. One or both eyelets may have one end fixed to and continuous with the ring, and one sharply pointed end contiguous with, but not continuous with, the ring, with the pointed end pointing inwards such that its external side lies at an acute angle to the outer circumference of the ring, so that the floss can enter the aperture by being pulled through the contact point between the pointed end of the eyelet and the ring, but can't easily exit the aperture once inside.

### FIELD OF THE INVENTION

The present invention relates to oral hygiene. In particular the invention relates to a device for the flossing of teeth.

### BACKGROUND TO THE INVENTION

Dental floss is a device, consisting of a length of fine string usually made of nylon or Teflon, which when pulled taught is used to scrape and clean the inter-proximal surfaces of the teeth.

Flossing is recommended as a means of cleaning between the teeth, an area where toothbrushing doesn't reach. This is particularly important in the back (molar) region of the mouth, where the inter-proximal (adjoining) tooth surface is a large flat area. Getting floss into this area of the mouth requires a certain degree of dexterity by the user.

Many people do not use floss correctly. The accepted correct use of floss involves wrapping a length of approximately 45 cm (1.5 ft) of floss around the long fingers, three or four times, to achieve an anchor. A short length of approximately 2 cm of floss is then stretched taught between the tips of the index fingers or one thumb and one index finger. This short length is worked between the teeth, which are cleaned by scraping the floss up down against the inter-proximal surfaces. The user then moves on to a fresh piece of floss by unwinding the floss off one hand, while simultaneously winding it onto the other. This process has several disadvantages. In particular, it requires the use of an uneconomically long piece of floss. It is also cumbersome, as it can be difficult to reach the back teeth with the thumbs, and the tight floss around the fingers can be uncomfortable.

Many flossing devices have been proposed as aids to dental flossing. These, however, have shortcomings such as; not incorporating a sufficient length of floss to clean the entire mouth; requiring the user to cut off and attach a length of floss to the device, a time-wasting procedure that often requires as much dexterity as flossing itself; requiring the user to attach a “head” of floss to a ‘handle”, said “head” often detaching from the “handle” during flossing and lodging between the teeth; requiring the fingers, thumbs and sometimes the entire device to be placed into the mouth, a difficult task to perform in the molar region; not incorporating a sufficiently taut section of floss to pass between tight contact points of the teeth; when caught between the teeth, the short fixed section of floss on many devices leaves little room to cut the floss to facilitate removal of the head or device.

WO2012103013A1 shows a device with two loops formed of a ribbon material, and a length of floss incorporated within each of the loops and also extending between the two loops. Two parallel lengths of floss extend between the loops at a fixed distance. Since only one length of floss is to be used between the teeth, the proximity of a second adjacent length in close proximity is inconvenient. The floss is also fixed to the loops, so that the region to be used between the teeth soon becomes worn and ineffective.

U.S. Pat. No. 5,086,792A shows a loop of floss that is incorporated within two bar-shaped gripping elements. Again, the two parallel length of floss are fixed in relatively close proximity, making use of a single length of floss inconvenient, and again the region of floss being used can become worn and ineffective quite quickly.

Some devices employ two finger rings to secure a length of floss between the rings, such as JPH10127668A. Although more convenient to use, the length of floss again soon becomes ineffective through abrasion in a particular region, and the floss must be frequently replaced, which is inconvenient.

The purpose of the present invention is to provide a device which ameliorates these shortcomings.

### SUMMARY OF THE INVENTION

Accordingly, there is provided a dental flossing apparatus comprising a single continuous loop of dental floss passing freely through and held by apertures, located either within the body of each of two rings, or in an eyelet on each of the rings, said rings suitable for placing on the long fingers of both hands.

This invention is designed to incorporate the advantages of conventional flossing but without the disadvantages of either conventional flossing or other flossing aids. The advantages include the ability to pull on the floss to move to a fresh section as one moves around the mouth, without having to remove the rings from the fingers; the apparatus is more comfortable on the fingers than conventional floss; the apparatus can be packaged individually for hygiene; the individual packaging and the small size allows it to be transported in a purse, wallet or pocket; the apparatus requires much less dexterity than conventional floss; the apparatus is very strong and exploits the strength of the user's fingers, allowing the user to apply considerable force to the surface of the tooth being cleaned and thus the removal of more dental plaque and calculus; the apparatus has no replaceable heads, like other devices, that can dislodge from the main body of the device and get stuck between the teeth; in the event of the floss getting caught between the teeth, there is enough slack on the loop of floss, unlike other devices, to allow the floss to be cut and removed. Two further advantages of the device are that it helps prevent both a sawing motion, often performed with standard floss where the user pulls the floss laterally between the teeth, and holding the floss too far away from the teeth, which can result in damage to the gums, both of which are ineffectual in cleaning.

In one embodiment of the invention, a section of sponge is incorporated into the loop of floss. This sponge can aid the cleaning of larger spaces between the teeth and remove food lodged between the teeth.

In another embodiment of the invention, said sponge is impregnated with a substance such as fluoride, chlorhexidine, triclosan or herbal extract, or a combination of substances.

### BRIEF DESCRIPTION OF THE DRAWINGS

The invention will be more clearly understood from the following description of an embodiment thereof, given by way of an example only, with reference to the accompanying drawings, in which:

FIG. 1 is a side view of a first embodiment of the dental apparatus;

FIG. 2 is a side view showing another embodiment of the apparatus; and

FIG. 3 shows a perspective view of a possible method of using the dental apparatus;

FIGS. 4a and 4b show a perspective view of an embodiment of part of the dental apparatus;

FIG. 5 shows a perspective view of another embodiment of part of the dental apparatus; and

FIG. 6 show a plan view of an embodiment of the dental apparatus prior to use.

### DETAILED DESCRIPTION OF THE PREFERRED EMBODIMENT

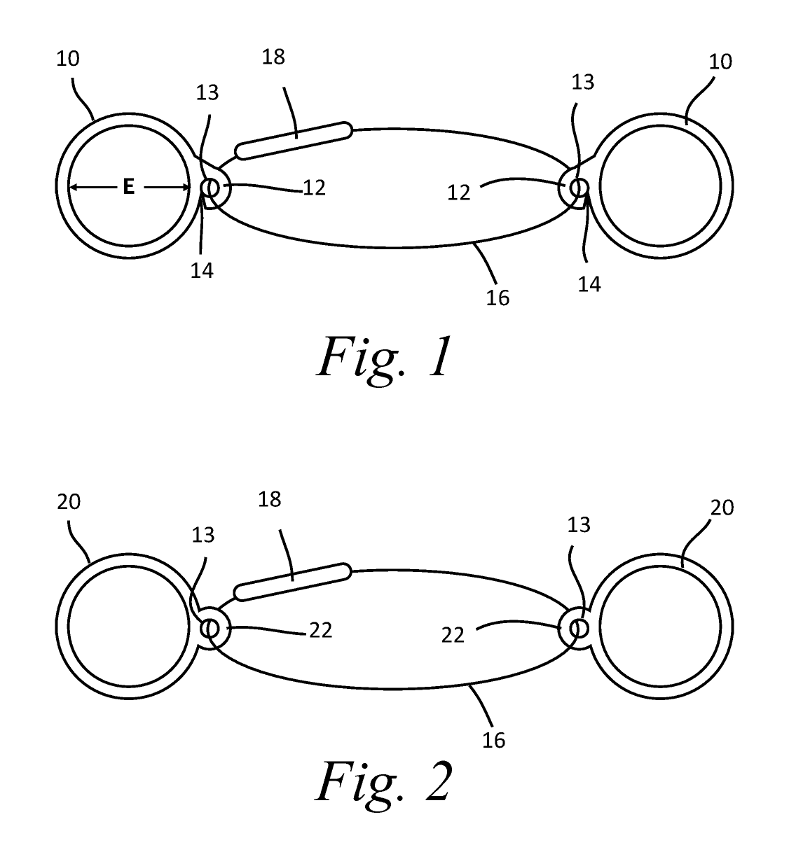

Referring now to the drawings and in particular to FIG. 1, the two rings 10 have an internal diameter E long enough to slide freely onto the long fingers of each hand i.e. approximately 2 cm. Said rings are ideally made of from rigidly-formed pieces of plastic, but can be made of any material. Said rings are ideally circular but can be any shape. Located at any point on the each ring is an eyelet 12. Said eyelet can be any shape and any size, but will be positioned on or proximal to the external circumference of the ring 10. At the centre of each eyelet is an aperture 13. Said aperture can be any shape and diameter, ideally varying from between 2 mm to 5 mm. Each eyelet 12 has one ending fixed to the ring 10 and one sharply pointed end 14 abutting and contiguous with, but not continuous with, the outer circumference of each of the rings 10, whereby the external side of the pointed end is at an acute angle to the outer surface of the ring. Said pointed end 14 allows the insertion of the loop of floss past the contact point where the pointed end 14 abuts the surface of the ring 10 and into the aperture 13, but doesn't easily allow the floss to come out. This process may be aided by a slight flexibility of the material of the eyelet, so that as the floss enters the smoothly narrowing gap between the pointed end 14 and the surface of the ring 10 the gap is widened sufficiently to allow the floss to pass. The inner surface of the aperture 13 where the pointed end 14 of the eyelet 12 touches the surface of the ring 10 presents an oblique surface which resists the accidental entry of the floss. The loop of floss 16 may be inserted during the manufacturing process or by the end-user.

A single continuous loop of dental floss 16, of approximate total length 14 cm (but may be any length) is held by the eyelets 12 by passing though the apertures 13 in both eyelets. The floss can move freely through the apertures.

Each eyelet 13 may lie in the same plane as the ring 10, however one or both eyelets could alternatively lie in a plane inclined to that of the ring, indeed the eyelet's plane could be perpendicular to that of the ring. The eyelet could be fixed to the ring either by being an integrally formed part of the same body of material as the ring, such as when manufactured by injection moulding, or when the ring and eyelet are cut or milled form the same piece of material, or the ring and eyelets could be separate components joined together by any means, in which case the eyelet could be formed from a different material.

Conveniently, the two rings 10 are identical, though this is not essential. Further the rings 10 need not be continuous closed circles, but could include a break, provided that they remain on the user's fingers during use.

A variation of the invention has a section 18 of the floss loop bearing or consisting of sponge material, which may be provided in a solid cylindrical or sausage-shaped tube of material. Further variations of the invention provide a section of sponge of varying length and diameter. Said section of sponge may be manufactured from cellulose, polyether foam, polyurethane foam or polyethylene foam, or any other material necessitated by the manufacturing process. Said section of sponge may be the means of closing the loop of floss, or may be attached to a pre-existing loop of floss by a number of means, such as stitching or knotting, bonding with chemically cured bonding agent, bonding with a light cured bonding agent, heat bonded, or any other method of attaching the sponge to the floss, as necessitated by the manufacturing process. In further variations of the invention, said section of sponge 18 may be impregnated with a substance, either singly or in combination, such as fluoride, chlorhexidine, triclosan, or herbal extract, but not solely confined to these substances. In different variations of the invention, the medicament can be in dry (such as a crystalline or powdered material soluble in saliva), or wet form (such as a liquid or gel). A further variation on the invention consists of two or more sections of sponge material, and they may be regularly distributed along the length of floss.

Referring to FIG. 2, in a further variation of the invention the eyelets 22 are continuous with rings 20, so that there no gap provided between a pointed end 14 of the eyelet and the surface of the rings 20. Said eyelets may be very small or practically non-existent whereby the apertures 13 are located within the bodies of the rings.

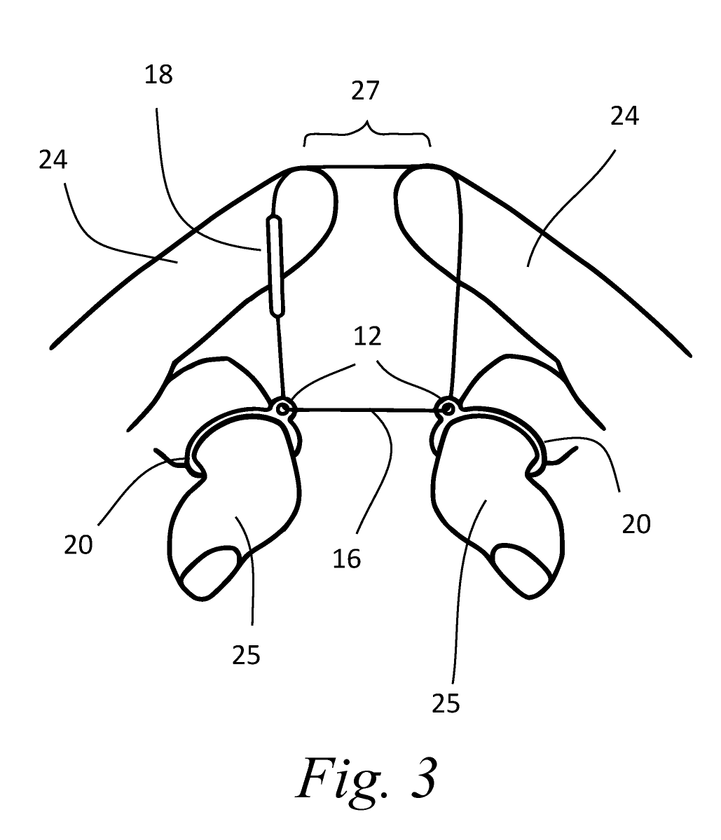

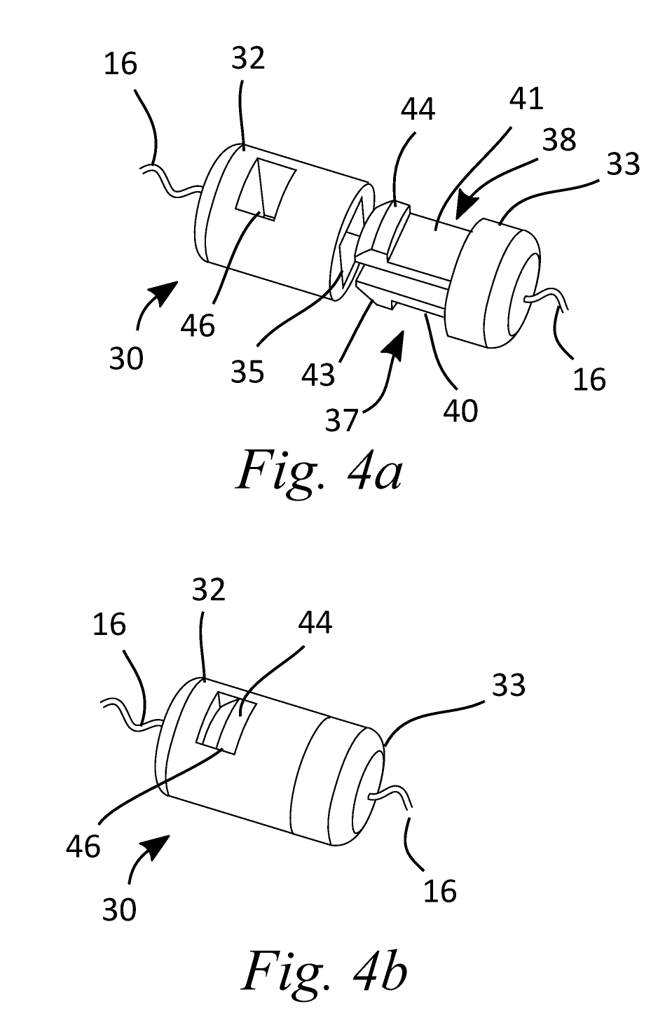

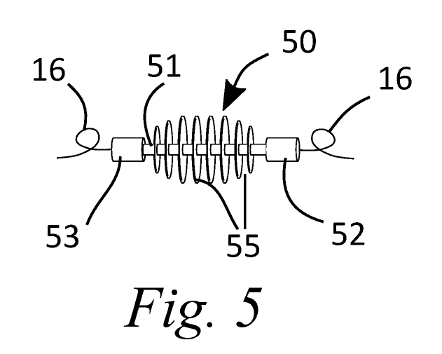

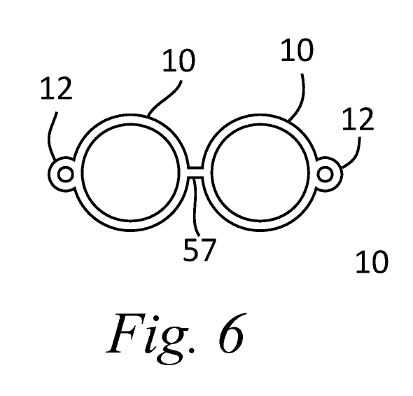

Referring to FIG. 3, bent long fingers of each hand hold the two rings 20, most conveniently the middle fingers 25. The user then uses the tips of the index fingers 24 to stretch taut a section 27 of the floss 16 of length approximately 2 cm. This taut section 27 of floss is then used to clean between the teeth in an up and down motion. This means that only the tips of the index fingers 24 and a short section of floss, and not the entire device or the thumbs, is required to be placed in the mouth. The anchorage of the rings and the dexterity of the index fingers, results in a strong and effective flossing tool. The floss may be advanced through the eyelets 12 to in order to move to a fresh section of floss 16 into the taut section 27, or bring the section of sponge material 18 (or one of the sections, if several pieces of sponge material are provided) between the index fingers.

Where the eyelets include a free pointed end that touches the outer surface of the rings, floss 16 may be provided in a ready-made loop, or the user may form a loop from a length of floss by knotting one end to another, and the floss inserted through the pointed end and the surface of the ring. Where the eyelet is formed with both ends continuous with the ring, or the eyelet formed within the body of the ring itself, the floss 16 must be threaded through the aperture of the eyelet before the loop is formed.

The above description refers to dimensions. These are typical only and the invention is not limited to them.

The above description relates to the preferred embodiments by way of example only. Many variations on the apparatus for delivering the invention, as would be clear to those knowledgeable in the field, are within the scope of the invention, whether or not expressly described.

What is claimed is:

1. A dental flossing apparatus comprising a single continuous loop of dental floss passing freely through and held by apertures, located either within the body of each of two rings, or in an eyelet on each of the rings, said rings suitable for placing on the long fingers of both hands.

2. A dental flossing apparatus, as claimed in claim 1, wherein at least one of the eyelets has one end fixed to and continuous with the ring, and one sharply pointed end contiguous with, but not continuous with, the ring wherein the pointed end points inwards such that its external side lies at an acute angle to the outer circumference of the ring, so that the floss can enter the aperture by being pulled through the contact point between the pointed end of the eyelet and the ring, but can't easily exit the aperture once inside.

3. A dental flossing apparatus, as claimed in claim 1, wherein the plane of at least one of the eyelets lies in the same plane as the ring

4. A dental flossing apparatus, as claimed in claim 1, wherein the plane of at least one of the eyelets lies in a plane inclined to the plane of the ring

5. A dental flossing apparatus, as claimed in claim 1, wherein the eyelet is integrally formed with the ring from the same material.

6. A dental flossing apparatus, as claimed in claim 1, wherein one or more sections of the loop of dental floss comprises a sponge material

7. A dental flossing apparatus, as claimed in claim 6, wherein said sponge material is made of polyester foam, cellulose, polyurethane foam or polyethylene foam.

8. A dental flossing apparatus, as claimed in claim 6, wherein said sponge material is attached to the floss by means of stitching, knotting, chemically-cured bond, light-cured bond or heat bond.

9. A dental flossing apparatus, as claimed in claim 6, wherein said sponge wherein one or more of said sections of sponge may be impregnated with a substance of artificial, natural or herbal origin.

10. A method of using a dental flossing apparatus, said apparatus comprising a single continuous loop of dental floss held by apertures located either within the body of each of two rings, or in an eyelet on each of the rings comprising the steps of placing the rings on one long finger of each hand, and placing the loop of dental floss round a second long finger from each hand so that the second long fingers can hold the floss under tension.

11. A method as claimed in claim 10, where in the loop of dental floss is pulled through the apertures in order to advance the loop of material and replace a region of used floss with a fresh length of floss.
